(19) United States
(12) Patent Application Publication
(10) Pub. No.: US 2006/0027227 A1
(43) Pub. Date: Feb. 9, 2006

(54) Volcano furnace

(76) Inventors: Steve Everett, Austin, TX (US); William Thomas Steadham, Corpus Christi, TX (US)

Correspondence Address: Mr. Steve Everett, 1619 Wheeless Lane, Austin, TX, 78723, US

(21) Appl. No.: 10/913,581

(22) Filed: Aug. 9, 2004

(51) Int. Cl. A47J 37/07; F24C 1/16; F24B 1/20; F24B 1/18

(52) U.S. Cl. 126/9 A; 44/530; 44/535; 126/500

(57) ABSTRACT

A method for the safe combustion of a solid fuel used in outdoor cooking or recreational heating, the method comprises a structure of the solid fuel, a wick for the ignition of a starter fuel, a shape and design of the structure that promotes the combustion process of the solid fuel by the formation of a space within the structure, wherein the combustion process is provisionally contained and controlled with a design that allows ambient air to enter into structure to increase the combustion process and a design that allows the provisionally controlled escape of combusted fuel gases. The combustion process is provisionally contained by a bonding layer that forms the internal combustion containment space within the structure and bonds the solid fuel sections attached to the bonding layer in place until bonding layer is consumed by the combustion process, collapsing the structure thereby igniting attached solid fuel sections.

### BACKGROUND OF THE INVENTION

1. Field of the Invention

This invention relates to the field of charcoal briquettes and other solid fuel compositions, and more particularly to their shape and design to achieve desired lighting and burn characteristics with respect to intended uses such as barbecue cooking and recreational heating needs such as fireplaces and campfires.

2. Brief Statement of the Related Art

Charcoal briquettes presently available are typically provided in a “pillow” shape which provides for reasonably satisfactory ease of manufacturing by the supplier and handling by the consumer. However, little attention has been paid to their burning characteristics as related to their configuration and material distribution. As is well known, such briquettes are typically used for cooking on a grill or the like by preparing a plurality of briquettes in a mounded configuration, igniting their surface by some ignition means such as lighter fluid, electric heaters, etc., and waiting until ignition of a significant portion of the briquettes has progressed until a majority of the exposed surface is ignited and burning has progressed inwardly toward the interior of the briquette. As burning proceeds inwardly from the surface of the briquette, a gray ash is formed thereon. Thus completion of the initial “ignition phase” of burning is identifiable by the formation of such visual ash on the briquette, and is defined herein as the time at which there is 60-75% visual ash formation on the briquettes. Thereafter the briquettes are typically spread under a grill or the like for cooking, and they continue to burn with an intense heat throughout a “burn phase”. For maximum performance of such briquettes it is desirable that the ignition phase be rapid so that the briquettes may be used for cooking without undue delay, and that the burn phase be extended to provide adequate cooking time for the use intended. It is further desirable to obtain such beneficial combustion performance in the most efficient manner with respect to the amount of fuel consumed.

There have been few prior art developments related to design of solid fuel articles for desired combustion performance. There has been some work at ornamental configuration of fuel briquettes, as well as geometrical configuration of briquettes to enhance ignition or burning by enhancing air supply, such as provision of external surface discontinuities such as ribs, flutes, groups, slots or the like, and internal openings and passages of various configurations. Such attempts may enhance commencement of ignition or overall combustion, but do not provide desired optimal ignition and burning characteristics.

There are also numerous prior art portable cooking and heat generating apparatuses known. For example, typical of such portable cooking/heating devices include charcoal grills, propane and/or natural gas grills, camping stoves, etc. For the most part, these portable, prior art cooking devices employ fuel compositions, e.g., propane, natural gas, naphtha liquid (charcoal lighter) that are highly flammable. Invariably, in the case of widely used cooking apparatuses employing charcoal and conventional, liquid charcoal lighter, the naphtha liquid is applied superficially to the charcoal prior to lighting. In some cases, one may purchase charcoal that is already treated with a naphtha liquid and where one would simply set fire to the paper bag. In either case, there exists the possibility of a flare-up in which the flames could cause injury or damage to clothing or items near the cooking area. Furthermore, there is always the possibility that some of the liquid charcoal lighter is simply vaporized and picked up by the food being cooked. As is well known, charcoal lighter, and for that matter most hydrocarbons, are toxic if ingested.

Obviously, what is needed is a portable cooking/heating method for the safe and efficient combustion of a solid fuel composition in which the primary or initial fuel source is contained within a combustible enclosure comprised of a solid fuel suitable for cooking or heating. Such a method would ideally comprise of a solid or semisolid primary fuel composition impregnated with a naphtha solution within a formed charcoal structure. Upon being lit, the structure, by design, would concentrate the resultant heat and flames internally by creating an internal furnace. In turn, the furnace action would greatly minimize the possibility of a dangerous flare-up while allowing the charcoal structure to properly burn as needed. After a proper amount of the “burn phase” has taken place, the structure will, by design, collapse in an intended fashion, providing an adequate cooking temperature and charcoal for cooking.

### BRIEF DESCRIPTION OF THE DRAWINGS

The invention may take many physical forms in parts or in an arrangement of parts, or in the preferred embodiments which will be described in detail in this specification and illustrated in the accompanying drawings which form a part hereof and wherein:

FIG. 1 is a perspective view of a self-kindling combustible structure according to the present invention.

FIG. 2 is a perspective exploded view of the structure of FIG. 1 and its individual components.

FIG. 3 is a sectional view taken about the side elevation view taken about the section line 3-3 as shown in FIG. 1 that illustrates the individual components of the invention in relation to one another.

FIG. 4 is a perspective view of the sectional side elevation of FIG. 3 that illustrates the individual components of FIG. 3 and better illustrates the underside of the invention.

FIG. 5 is a sectional view taken about the side elevation view taken about the section line 3-3 as shown in FIG. 1 that illustrates the individual components of the invention in relation to one another upon the introduction of a flame to the primary fuel source.

FIG. 6 is a sectional view taken about the side elevation view taken about the section line 3-3 as shown in FIG. 1 that illustrates the individual components of the invention in relation to one another during an intermediate burning phase and once the inside of the invention begins to be consumed by the fire and a furnace-like action begins to take place within the invention.

FIG. 7 is a sectional view taken about the side elevation view taken about the section line 3-3 as shown in FIG. 1 that illustrates the individual components of the invention in relation to one another during the late burning phase and once the primary fuel source has been completely consumed and the remaining component of the invention continues to be consumed by fire. FIG. 7 also illustrates a weakening of a bonding layer as the furnace-like action continues to concentrate the heat within the invention.

FIG. 8 is a side elevation with portions removed of the invention in its final burning phase once the bonding layers have been completely consumed by the fire and the remaining sections are collapsed by gravity and offer a suitable cooking means as they continue to be consumed by the fire.

FIG. 9 is a perspective view of a self-kindling combustible structure that is arranged in parts according to the present invention.

FIG. 10 is a sectional view taken about the side elevation view taken about the section line 10-10 as shown in FIG. 9 that illustrates the individual components of the invention in relation to one another.

FIG. 11 is a sectional view taken about the side elevation view taken about the section line 11-11 as shown in FIG. 9 that illustrates the individual components of the invention in relation to one another and more clearly illustrates the internal structures designed to collapse.

FIG. 12 is a perspective view of the invention with portions removed to illustrate the preferred stacking method of the components of FIG. 9 in order to maintain a steady flow of air through the invention required for the internal furnace-like action.

FIG. 13 is a perspective exploded view of the components of FIG. 9 and more clearly identifies their individual structures and components.

FIG. 14 is a side elevation with portions removed of a possible alternative design to the invention.

FIG. 15 is a perspective view of a possible alternative design of the invention in which the material is formed to resemble a stack of logs.

### DETAILED DESCRIPTIONS OF THE PREFERRED EMBODIMENTS

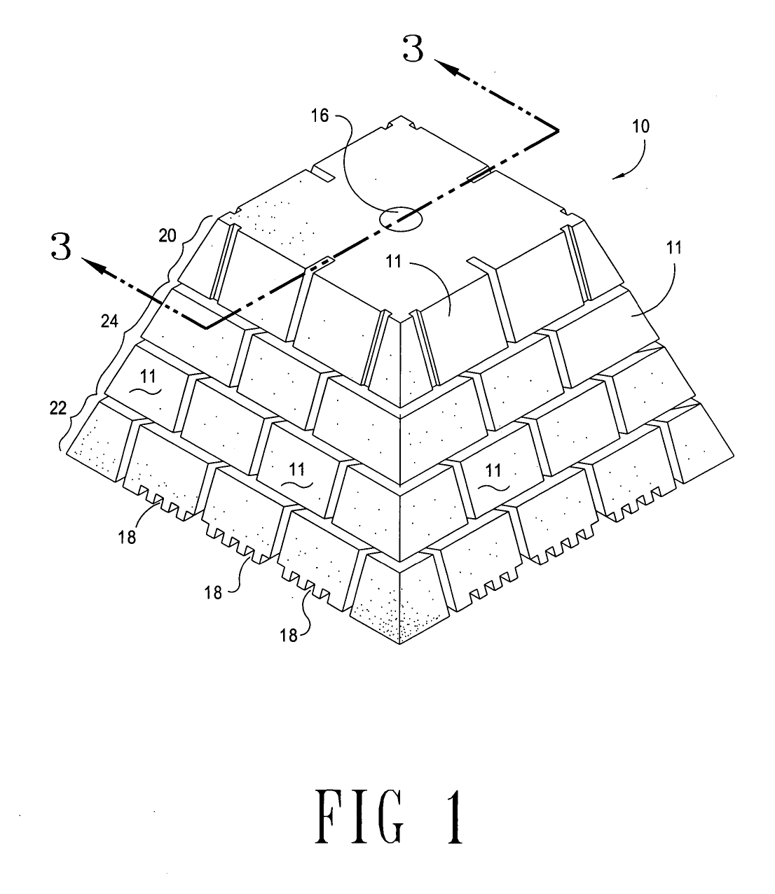

Referring now to the drawings wherein the illustrations are for the purposes of illustrating the preferred embodiments of this invention only and not for the purposes of limiting same, FIG. 1 illustrates an innovative solid fuel package design A. Although the solid fuel package design is primarily designed for and will hereafter be described for use in a barbecue grill for creating a charcoal fire thereon, it can be apparent that the innovative concept described may be adapted for other environments and situations in which it would be necessary to start a fire or generate heat such as in a campfire or fireplace. The molded structure 10 is in one preferred embodiment comprised of a structure that is approximately pyramidal in shape.

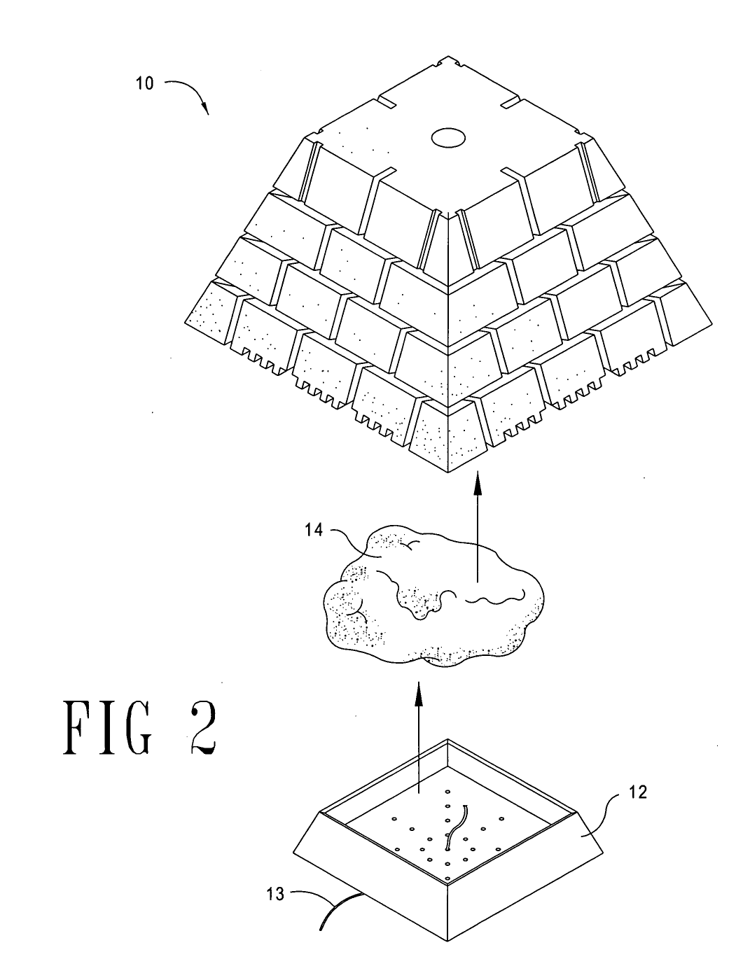

Referring now to FIG. 2, the solid fuel package design A is comprised of a molded structure 10 which houses within a primary fuel source 14, a means of ignition 13 and a base panel 12. The base panel 12 preferably contains the primary fuel source 14 within the structure 10 and holds the means of ignition 13 securely in place prior to ignition. The structure 10, ignition means 13 and the base panel 12 are entirely combustible. Preferably, the primary fuel source 14 is comprised of a porous non-toxic material that has been treated with a naphtha solution or similar suitable liquid fuel. In the same way, the interior of the structure 10 and the base panel 12 may be treated with or impregnated with a naphtha liquid or any suitable liquid fuel to accelerate combustion.

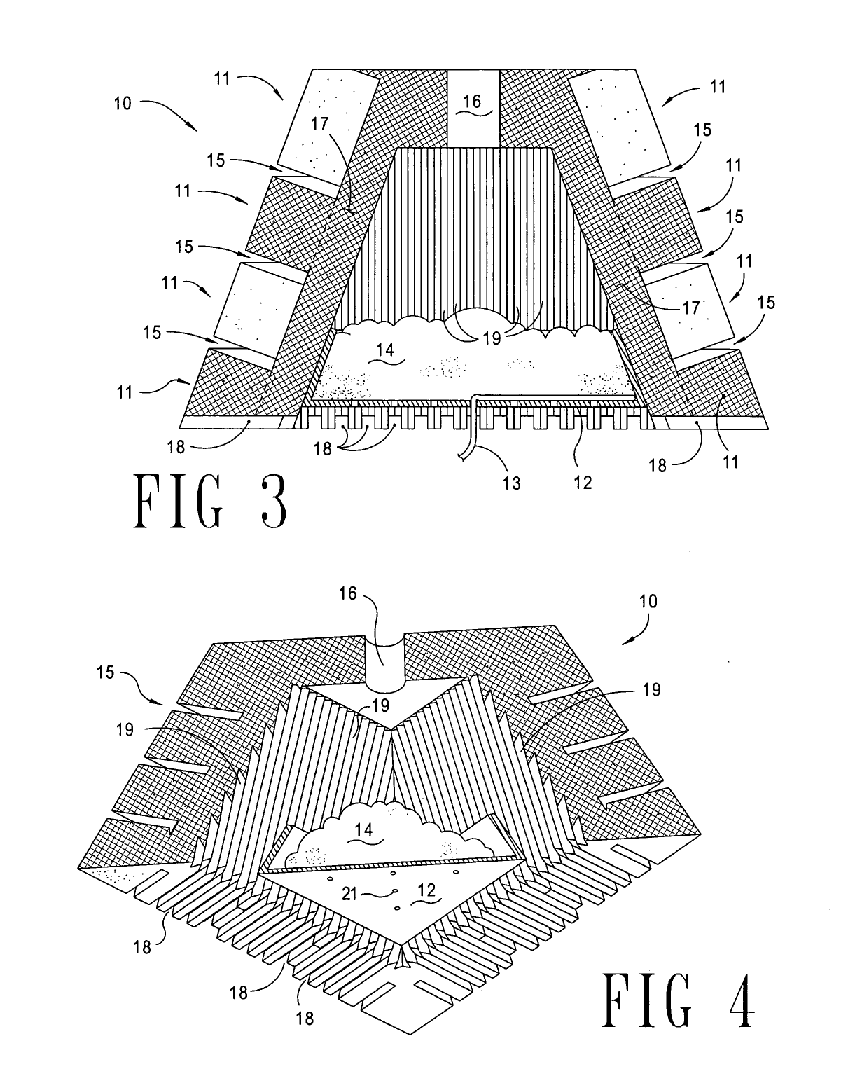

With reference to FIG. 3, the molded structure 10 in one preferred embodiment is formed from two elements. The first elements 11 are provided as formed sections. These formed sections 11 are molded as to approximately form a pyramid in shape when stacked together. The molded structure 10 further comprises a second element 17 which is a bonding layer of combustible fuel similar or identical in composition to the formed sections 11 and which is molded with a plurality of apertures 18 along the base. The bonding layer 17 is also comprised of an exhaust aperture 16 at the uppermost portion and a plurality of interior ribs 19 lining the interior surface. The two elements of the molded structure 10 may be molded together or later joined and bonded using mechanical or chemical means in such a way as to allow a sectional gap 15 between the formed sections 11.

The solid fuel package design A is comprised of an ignition means 13 that is contained within the molded structure 10 and is in physical contact with the primary fuel source 14 and the base panel 12.

With reference now to FIG. 4, the molded structure 10 in one preferred embodiment is comprised of interior ribs 19 that allow a greater surface area within the structure than would be available with a smooth interior surface. The interior ribs 19 also create both a plurality of apexes that may catch fire quicker and channels that serve to distribute the heat along the interior walls. The base panel 12 in one preferred embodiment has a plurality of perforations 21.

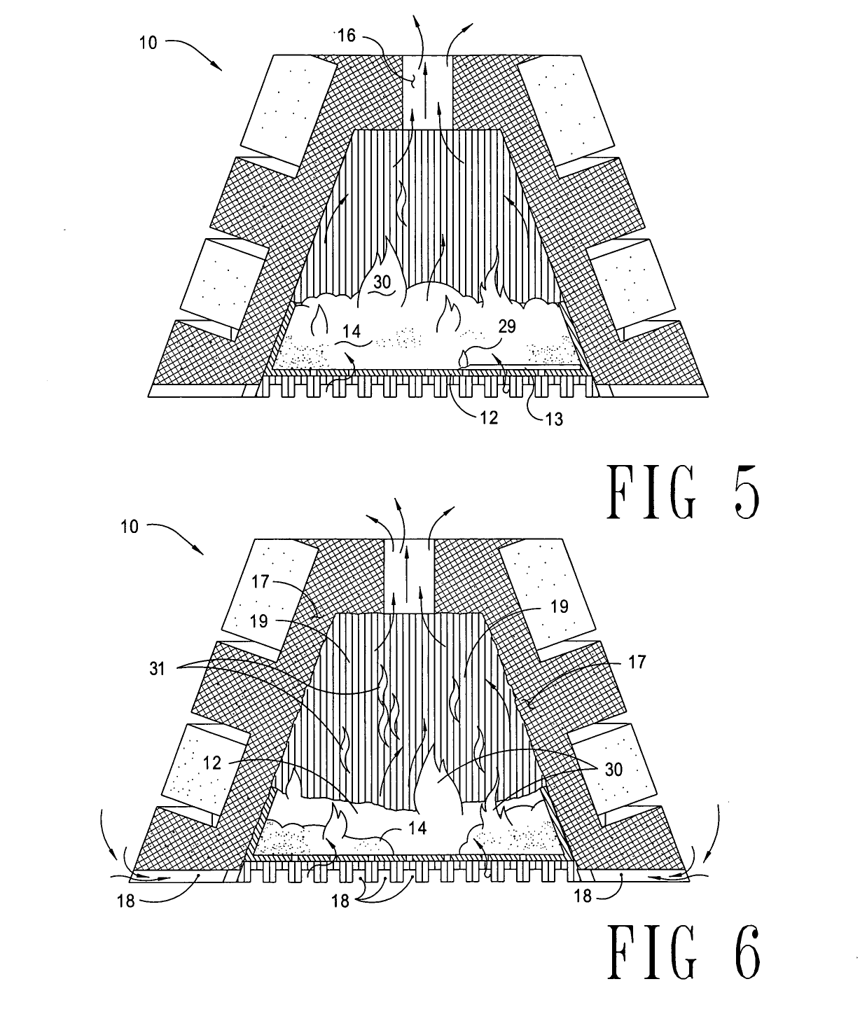

Referring now to FIG. 5, the ignition means 13 is comprised of an appropriate flammable composition and will rapidly burn when introduced to a flame 29. As the ignition means 13 is burned away, the introduced flame 29 will contact the primary fuel 14 and the base panel 12. The resulting contact will ignite the primary fuel 14 and create an internal primary flame 30. As the primary fuel source 14 is consumed by the flames 30, resultant gases and heat will be expelled from the molded structure 10 by means of an exhaust aperture 16. The expelled heat is inappropriate for cooking since the flames 30 may contain hazardous chemicals or by-products.

With reference now to FIG. 6, the molded structure 10 creates a furnace-like environment within as the remaining primary fuel 14 is nearly entirely consumed by its own flames 29. The resultant heat is carried and distributed throughout the interior of the structure 10 by means of the interior ribs 19. As the aforementioned interior ribs 19 are introduced to the primary fuel flames 30 and the interior heat, they will reach an appropriate ignition point at which time the molded structure 10 will begin to combust and generate flames 31 along the inner section of the binding layer 17.

As the heat intensifies within the molded structure 10, a thermal draft will be created within. As the gases and heat generated by the combustion of the primary fuel 14 an the interior ribs 19 escape by means of an exhaust aperture 16, oxygen will be introduced from the ambient environment by means of base apertures 18 and will be carried along the inside of the molded structure 10 by means of the interior ribs 19. Said thermal draft supplies a greater amount of oxygen for combustion thereby increasing the interior temperature of the molded structure and is resultant in a furnace-like environment within the molded structure.

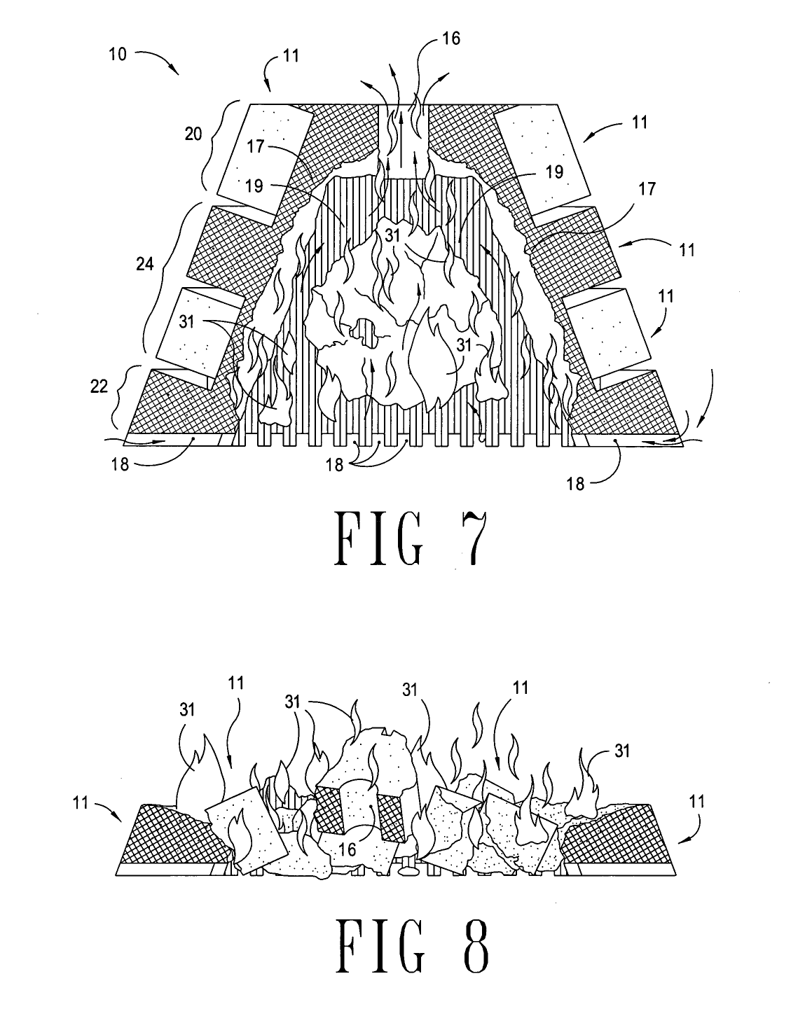

Referring now to FIG. 7, once the molded structure 10 is in its late burning phase, the only fuel being consumed by the flames 31 is the interior of the structure, 10 and more specifically the binding layer 17. The furnace-like environment within continues to concentrate the heat within the structure 10 as the interior ribs 19 are consumed by the flames 31.

As the heat intensifies and the binding layer 17 is consumed within the molded structure 10, the furnace-like action will aid in the concentration of the heat within by drawing in more oxygen through the base apertures 18 located on the base section indicated at 22 and venting the gases through the exhaust aperture 16. As said binding layer 17 is consumed, the formed sections generally indicated at 11 will become less firmly attached to the molded structure 10. Primarily affected will be the crown section indicated by 20 and the intermediate sections indicated at 24. Said binding layer 17 will continue to burn away throughout the later burning phase, eventually releasing the formed sections 11 and allowing said formed sections 11 to collapse the structure 10 by gravity force.

Referring now to FIG. 8, once the invention reaches its final burning phase it will have collapsed upon itself after being affected by a combination of internal combustion of the molded structure of FIG. 7 and indicated by 10, and gravity force. The formed sections, generally indicated by 11, are exposed in their entirety to the ambient atmosphere and are exposed to the existing flames 31 previously from within the said molded structure. The internal furnace-like action is no longer possible during the final burning phase as the aforementioned molded structure has collapsed upon itself, hereby indicating a suitable cooking means.

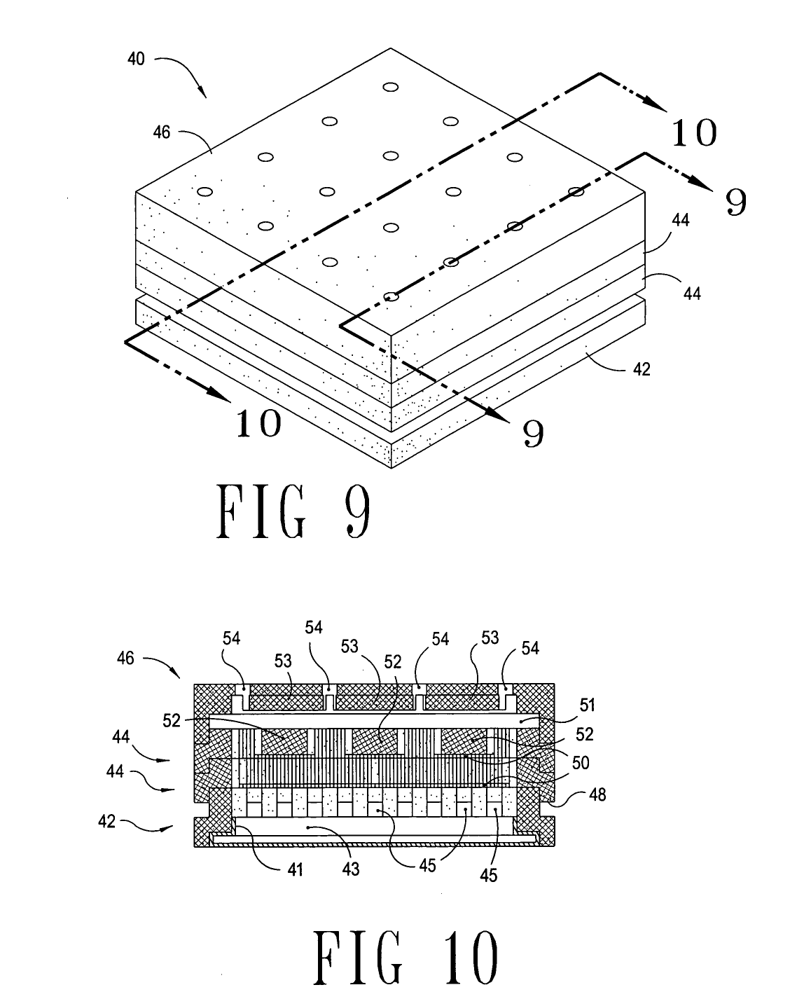

Referring now to the drawings wherein the illustrations are for the purposes of illustrating the preferred embodiments of this invention only and not for the purposes of limiting same, FIG. 9 illustrates an innovative solid fuel package design B. Although the solid fuel package design B is primarily designed for and will hereafter be described for use in a barbecue grill for creating a charcoal fire thereon, it can be apparent that the innovative concept described may be adapted for other environments and situations in which it would be necessary to start a fire or generate heat such as in a campfire or fireplace. The joined structure 40 is in one preferred embodiment comprised of a plurality of structures that are stackable to a height deemed appropriate for its application.

The solid fuel package design B is comprised of three primary components. The joined structure is comprised of a base section 42, a plurality of intermediate sections 44, and a crown section 46.

Now referring to FIG. 10, the solid fuel package design B is comprised of three primary components; which, work cooperatively to create an interior furnace-like chamber to facilitate the combustion and eventual collapse of the interior formed structures 52 and 53. The base section 42 is molded as to allow a base panel 41 to be introduced within said base section 42. Said base panel 41 contains a recessed area 43 of sufficient size and design to contain a volume of primary solid or semisolid flammable primary fuel. The base section 42 also contains a plurality of apertures 45 upon the uppermost section. A plurality of intermediate sections 44 may be used to create the solid fuel package design B, and consist of a molded form that provides an interlocking method by means of a lip 48, a plurality of collapsible structures 52, and a recessed section 50 to assist in the flow of air through the structure and provide a greater surface area for combustion. A crown section 46 is molded as to interlock with the intermediate sections 44. Said crown section 46 is comprised of a plurality of collapsible structures 53 and venting apertures 54. The crown section 46 is also molded as to provide a substantial recessed section 51 as to provide a means of collecting and concentrating interior heat.

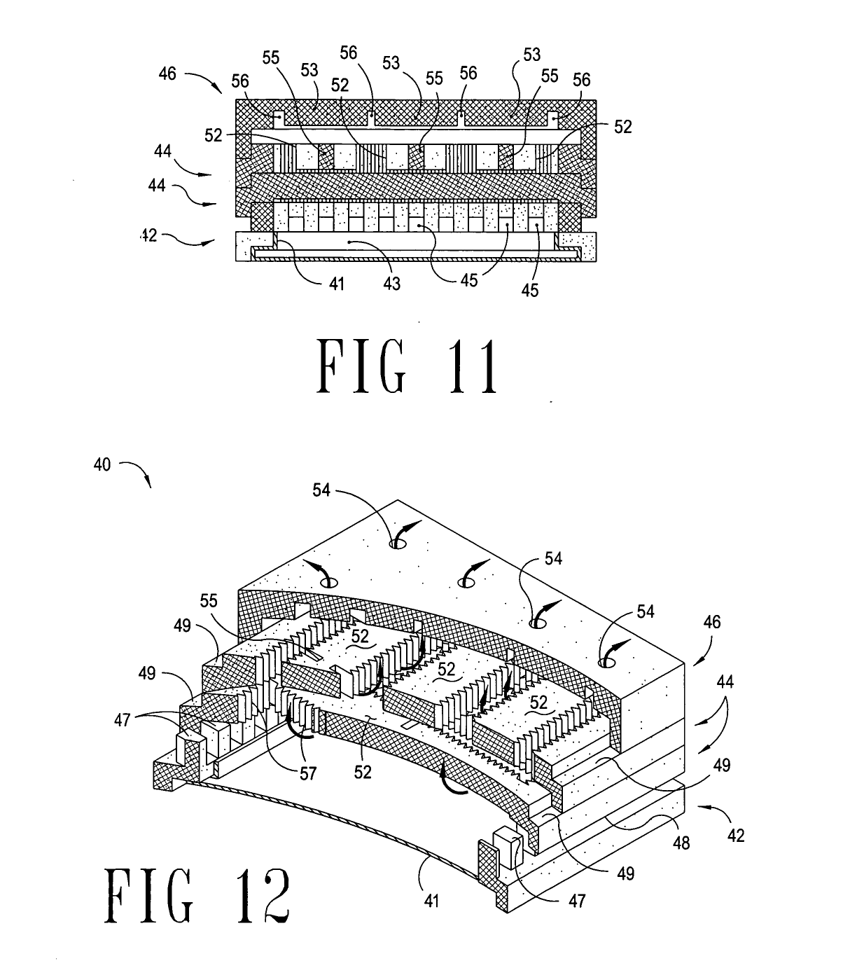

Referring to FIG. 11, the solid fuel package design B is shown to comprise of three primary components; which, work cooperatively to create an interior furnace-like chamber to facilitate the combustion and eventual collapse of the interior formed structures 52 and 53. The base section 42 is molded as to allow a base panel 41 to be introduced within said base section 42. Said base panel 41 contains a recessed area 43 of sufficient size and design to contain a volume of primary solid or semisolid flammable primary fuel. The base section 42 also contains a plurality of apertures 45 upon the uppermost section. A plurality of intermediate sections 44 may be used to create the solid fuel package design B, and contain a plurality of collapsible structures 52. Said structures contain predetermined structural weaknesses hereby referred to as collapsing points 55 created purposely to be consumed by flames after a predetermined amount of time. A crown section 46 is molded as to interlock with the intermediate sections 44. Said crown section 46 is comprised of a plurality of collapsible structures 53. Said crown section 46 contains a plurality of predetermined structural weaknesses hereby referred to as collapsing points 56 created purposely to be consumed by flames after a predetermined amount of time.

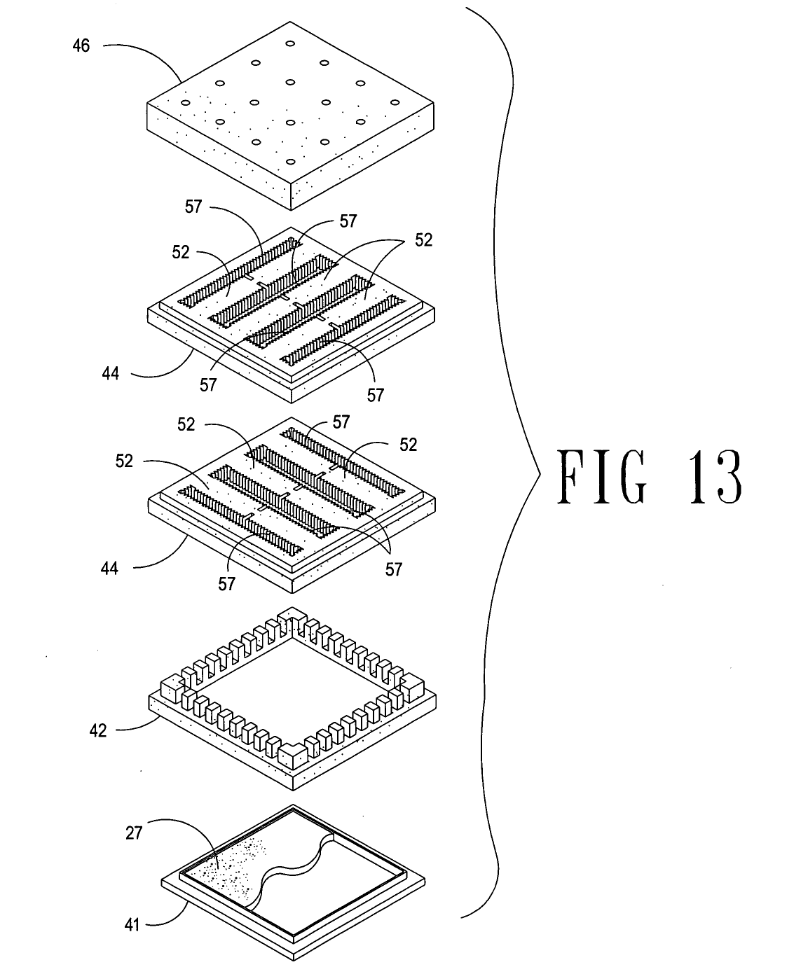

Referring now to FIG. 12, the solid fuel package design B of FIG. 9 is comprised of three primary components. The joined structure is comprised of a base section 42, a plurality of intermediate sections 44, and a crown section 46.

Whereas the base section 42 has been introduced to a flame by means of the base panel 41 and a means of ignition, a thermal draft will begin to exist within the structure generally indicated at 40. The base section 42 also contains a plurality of tooth-like structures 47 that form a means for the introduction of oxygen once an intermediate section 44 has been set upon said base section 42. A plurality of intermediate sections 44 may be used to create the solid fuel package design B, and consist of a molded form that provides an interlocking method by means of a lip 48 and seat 49, a plurality of collapsible structures 52, which contain irregular apertures indicated at 57 which allow a greater surface area that may be exposed to flames and heat. A crown section 46 is molded as to interlock with the intermediate sections 44. Said crown section 46 contains venting apertures 54 that allow resultant heat and gases to escape after traversing through a plurality of crisscrossed collapsible structures 52. The arrows generally indicate the flow of air, heat and gases within the solid fuel package design B and to the ambient environment.

Referring now to FIG. 13, the solid fuel package design B of FIG. 9 is comprised of three primary components. The joined structure is comprised of a base section 42, a plurality of intermediate sections 44, and a crown section 46.

Said base panel 41 is comprised of a means of containment that will allow a quantity of primary solid or semisolid flammable primary fuel 27 to be contained therein. In a similar manner, the base panel 41 may be impregnated with a quantity of flammable fuel.

A plurality of intermediate panels 44, designed to fit in an interlocking fashion are to be set upon one another in a manner through which the collapsible sections 12 are perpendicular to one another or otherwise opposing directions as to allow a proper flow of air and heat through the irregular apertures 57.

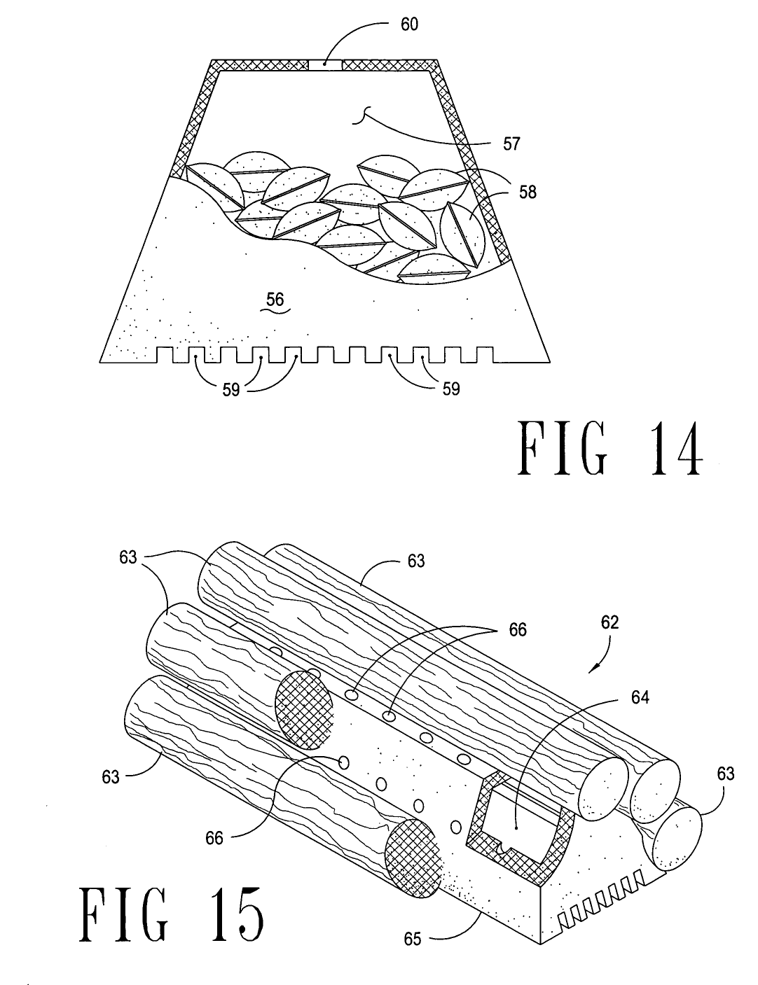

With reference now to FIG. 14, the invention may undertake several design changes without affecting the functionality of the invention. As illustrated, the molded structure 56 may provide a collapsible furnace even when the primary fuel source 58 is comprised of a charcoal material comparable to the structure 56. Such a design would allow a furnace-like environment to be created within an interior chamber generally indicated at 57, through which oxygen would be introduced from the ambient environment by means of air inlet apertures 59 and exhausted through an exhaust aperture 60.

Lastly, with reference to FIG. 15, the invention may undertake several design changes without affecting the functionality of the invention. As illustrated, the molded structure 62 may undertake a stylized form through which a molded structure 65 would provide a furmace-like chamber 64 capable of creating and concentrating a required amount of heat and expelling heat and flames through exhaust apertures 66. An additional solid fuel source 63 may be bonded or otherwise joined to the structure 65 in a manner as to allow the molded structure 65 to cause the ignition of a quantity of additional solid fuel sources 63. Said additional solid fuel source 63 may be of the same or similar compound as the molded structure 65. Likewise, the additional solid fuel source 63 may comprise of a substance suitable for the generation of heat.

The invention has been described with reference to preferred embodiments. It is obvious that alterations to the design and composition of materials may be adapted according to individual tastes or needs. It is intended to include all such modifications and alteration insofar as they come within the scope of the claims or the equivalents thereof.

What is claimed is:

1. A method for the safe and efficient combustion of a solid fuel comprising:
an innovative solid fuel package design; comprising;
a formed structure; comprising:
a construction from a combustible solid fuel;
a plurality of formed solid fuel sections;
a formed combustible bonding layer;
a shape or design intended for the focus and containment of heat within said structure;
a quantity of apertures in said structure intended for the introduction of oxygen into an internal chamber in order to create and intensify internal combustion within said structure;
a quantity of apertures in said structure intended for the exhaust of gases and heat from within said structure as to create a draft effect within and through said structure in order to create an internal furnace effect within said structure;
a shape or design intended to minimize the risk of injury or damage from leaping flames;
a shape or design intended to facilitate the collapse of said structure upon the combustion of said bonding layer; and
a primary fuel source to be held within said structure;
a base panel for containing said primary fuel; and
a means of ignition positioned within said base panel.

2. The method of claim 1 wherein said package design is pyramidal in shape.

3. The method of claim 1 wherein said package is comprised of a shape having five or more sides.

4. The method of claim 1 wherein said package is cylindrical in shape.

5. The method of claim 1 wherein said formed structure is comprised of a quantity of stackable sections.

6. The method of claim 1 wherein said package design is impregnated with a flammable fuel accelerant or incendiary mixture.

7. The method of claim 1 wherein said package design comprises a formed structure created from charcoal fuel.

8. The method of claim 1 wherein said package design comprises a formed structure created from alternate organic solid fuels.

9. The method of claim 1 wherein said package design comprises a formed structure created from alternate synthetic solid fuels.

10. The method of claim 1 wherein said package design comprises a means for the support of a cooking or heating rack upon or within said formed structure.

11. The method of claim 1 wherein said package design comprises a structure intended to allow one or more walls to remain upright until completely consumed by flames.

12. The method of claim 1 wherein said package design comprises a structure that is intended to maintain its original shape until burned away entirely.

13. The method of claim 1 wherein said package design comprises a primary fuel source that is of the same composition as the formed structure.

14. The method of claim 1 wherein said package design comprises a structure designed as to imitate a quantity of natural logs.

15. The method of claim 1 wherein said package design comprises a formed structure composition not intended for cooking purposes.

16. The method of claim 1 wherein said package design does not require a base panel.

17. The method of claim 1 wherein said package design does not require a primary fuel source.

18. The method of claim 1 wherein said package design includes a formed structure intended for saturation with a liquid fuel.

19. The method of claim 1 wherein said package design comprises a binding layer that is compositionally different from the formed structure.

20. The method of claim 1 wherein said package design comprises a formed structure containing a singular aperture for the introduction of oxygen into said combustion chamber.
